(19) United States
(12) Patent Application Publication
(10) Pub. No.: US 2026/0252332 A1
(43) Pub. Date: Aug. 27, 2026

(54) METHOD, APPARATUS, DEVICE, AND MEDIUM FOR MANAGING APPLICATION PROGRAMMING INTERFACE

(71) Applicant: Beijing Zitiao Network Technology Co., Ltd., Beijing (CN)

(72) Inventor: Zhuozhi JI, Beijing (CN)

(21) Appl. No.: 19/550,011

(22) Filed: Feb. 25, 2026

(30) Foreign Application Priority Data
Feb. 25, 2025 (WO) PCT/CN2025/079086

(51) Int. Cl. G06F 8/60; G06F 8/41; G06F 11/34; G06F 11/3668

(52) U.S. Cl. CPC G06F 8/60; G06F 8/42; G06F 11/3457; G06F 11/3684; G06F 11/3688

(57) ABSTRACT

A method, an apparatus, a device, and a medium for managing an application programming interface are provided. In a method, description data of the application programming interface of an application is obtained. Constraint data is obtained, the constraint data represents a constraint for a field specified by the description data, and the constraint data is represented in a natural language. Simulation code for simulating a function of the application programming interface is determined by using a machine learning model based on the description data and the constraint data. The simulation code is deployed in an execution environment of the application to generate a simulation interface for simulating the function of the application programming interface of the application.

### CROSS REFERENCE

This application claims priority to PCT Application No. PCT/CN2025/079086, filed on Feb. 25, 2025 and entitled “METHOD, APPARATUS, DEVICE, AND MEDIUM FOR MANAGING APPLICATION PROGRAMMING INTERFACE”, the entirety of which is incorporated herein by reference.

### FIELD

Implementations of the disclosure generally relate to software development, and in particular, to a method, an apparatus, a device, and a computer-readable storage medium for managing an application programming interface in a software development process.

### BACKGROUND

In software developments, a Mock technology is a method that supports testing and development by simulating behaviors of objects or services. In particular, the Mock technology may generate Mock code to create virtual objects (e.g., functions or services, etc.) to replace real components. These virtual objects may simulate behaviors in real environments, helping developers to conduct testing without relying on external systems or services. Generally, the developers need to manually write and generate the Mock code. Although an automatic code generation tool has been proposed, the generated Mock code is difficult to be understood and adjusted, and may not meet testing requirements. At this point, it is desirable to manage an application programming interface in a more accurate and efficient manner and generate corresponding Mock code.

### SUMMARY

In a first aspect of the disclosure, a method for managing an application programming interface is provided. In the method, description data of the application programming interface of an application is obtained. Constraint data is obtained, the constraint data represents a constraint for a field specified by the description data, and the constraint data is represented in a natural language. Simulation code for simulating a function of the application programming interface is determined by using a machine learning model based on the description data and the constraint data. The simulation code is deployed in an execution environment of the application to generate a simulation interface for simulating the function of the application programming interface of the application.

In a second aspect of the disclosure, an apparatus for managing an application programming interface is provided. The apparatus includes: a description data obtaining module configured to obtain description data of the application programming interface of an application; a constraint data obtaining module configured to obtain constraint data, the constraint data representing a constraint for a field specified by the description data, and the constraint data being represented in a natural language; a determining module configured to determine a simulation code for simulating a function of the application programming interface by using a machine learning model based on the description data and the constraint data; and a generating module configured to deploy the simulation code in an execution environment of the application to generate a simulation interface for simulating the function of the application programming interface of the application.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a non-transitory computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the content described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an implementation of the disclosure;

FIG. 2 shows a block diagram for managing an application programming interface according to some implementations of the disclosure;

FIG. 3 shows a block diagram of an architecture of a module for managing an application programming interface according to some implementations of the disclosure;

FIG. 4 shows a block diagram of deploying simulation code in a gateway environment according to some implementations of the disclosure;

FIG. 5 shows a block diagram of deploying simulation code in a webpage integration environment according to some implementations of the disclosure;

FIG. 6 shows a block diagram of deploying simulation code in a container environment according to some implementations of the disclosure;

FIG. 7 shows a flowchart of a method for managing an application programming interface according to some implementations of the disclosure;

FIG. 8 shows a block diagram of an apparatus for managing an application programming interface according to some implementations of the disclosure; and

FIG. 9 shows a block diagram of a device in which various implementations of the disclosure may be implemented.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the terms “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “in response to” as used herein means a state in which a respective event occurs or a condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

In software developments, the Mock technology may support testing and development by simulating behavior of objects or services. In particular, the Mock technology may generate Mock code to create virtual objects (e.g., functions or services, etc.) and replace real components. These virtual objects may simulate behaviors in real environments, helping developers to conduct testing without relying on external systems or services.

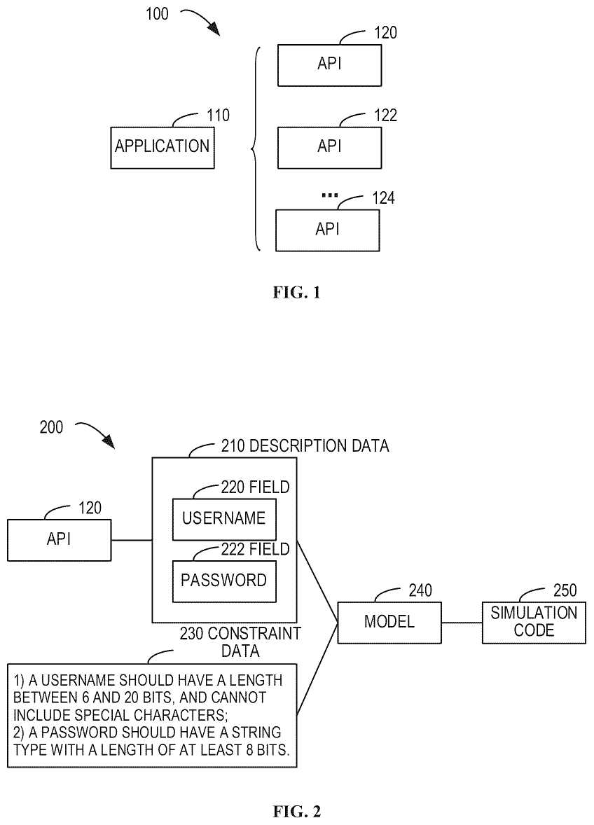

In the process of software development, an interface Mock is a very critical link. An application environment according to some implementations of the disclosure is described with reference to FIG. 1. FIG. 1 shows a block diagram 100 of an application environment according to an implementation of the disclosure. As shown in FIG. 1, an application 110 may include a plurality of application programming interfaces (APIs), e.g., an API 120, an API 122, . . . , and an API 124. There may be dependencies between various APIs, and the Mock solution may support the developer to simulate dependency objects in a test environment without relying on the actual external system. In this way, the developer may be supported to develop respective APIs in a more independent manner.

Most existing Mock solutions rely on developers to manually write code to simulate a response of an interface. This is not only inefficient but also prone to errors for human negligence and other reasons. With the development of software technology, numerous Mock platforms have emerged, and these platforms may support configuration generative form and then randomly generate content. However, on one hand, the content generated by the platform is often difficult to understand, which brings many troubles to developers in subsequent interface debugging, and increases the understanding cost and the communication cost. On the other hand, the generative form itself is difficult to write, and developers are required to have high technical levels and complex configuration skills. For complex interface scenarios, the writing difficulty is greatly improved.

Furthermore, fields of many interfaces have a format constraint, e.g., a field “phoneNumber” requires that the content of the field conform to specific format requirements of a phone number. However, it is difficult for the existing Mock platform to make full use of the format constraint information included in this field name, and cannot accurately generate the Mock data conforming to semantic and format requirements. This results in a large amount of manual intervention and correction in practical applications, and seriously affects the overall efficiency and quality of software development. As the complexity of the API continues to increase and the pressing need from the development team for fast iterative and efficient collaboration, it is desirable to provide a more intelligent and higher degree of the Mock solution during API development and testing.

### Summary of Interface Management

In order to at least partially solve the deficiencies in the prior art, according to an implementation of the disclosure, a method for managing an application programming interface is provided. In recent years, the machine learning model technology has tremendous development, and the powerful natural language understanding and generation capability of the model provides a new idea and possibility for solving various complex software technical problems. In summary, the technical solution of the disclosure may utilize the powerful processing capability of the machine learning model to generate the simulation code for the application programming interface, thereby improving the development and testing performance of the application.

A summary according to one implementation of the disclosure is described with reference to FIG. 2, and FIG. 2 shows a block diagram 200 for managing an application programming interface according to some implementations of the disclosure. As shown in FIG. 2, for an application programming interface (e.g., an API 120) in the application 110, description data 210 of the application programming interface may be obtained. Here, the description data 210 may be defined in an interface description language (IDL) and generally includes an API to external interaction interface (e.g., an input interface and an output interface) and a definition of the data structure involved, and the like. Assuming the API 120 performs a user registration function, the data structure involved in the description data 210 may include: a field 220, an identifier of which is username and which is used to store a username; and a field 222, an identifier of which is a password and which is used to store a password.

Further, constraint data 230 may be obtained. The constraint data 230 may represent a constraint for a field specified by the description data 210, and the constraint data is represented in a natural language. For example, for fields 220 and 222 in the description data 210, the constraint data may specify: 1) a username should have a length between 6 and 20 bits, and cannot include special characters; 2) a password should have a string type with a length of at least 8 bits, etc. The simulation code 250 for simulating a function of the application programming interface 120 may be determined by using a machine learning model (e.g., a model 240) based on the description data 210 and the constraint data 230. In the Mock environment, the Mock code may be a specific example of the simulation code. It should be understood that the simulation code 250 is code that may be compiled and executed correctly. The simulation code 250 may be deployed in an execution environment of the application to generate a simulation interface for simulating the function of the application programming interface of the application 120.

The existing Mock platform or the manner of manually writing the Mock code cannot fully mine the format and semantic constraints implied by the interface field name itself. For example, a content of a field “phoneNumber” should follow a particular phone number format specification; a field “email” should follow a particular email format specification, etc. However, it is difficult for the existing technical solutions to automatically generate accurate Mock data according to such semantic information. Different from the existing technical solutions, the proposed technical solution may accurately understand and utilize the semantic information of fields. Specifically, by means of the machine learning model, the disclosure enables the interface Mock process to deeply understand the semantics expressed by the field names, so that the Mock content conforming to the field semantic requirements is generated accurately, and errors caused by insufficient understanding of the fields are reduced.

Although the existing Mock platform may support a generative form, the generative form is difficult to write, the developers are required to have deep technical knowledges and rich configuration experiences, and the readability of the generated Mock content is poor. This makes it difficult for developers to use, debug, and maintain a Mock interface. Different from the existing technical solutions, the proposed technical solution may reduce the complexity of the generative configuration and improve the readability of the Mock code. The disclosure may simplify the configuration process, reduce the complexity of the generative configuration, and support developers to more easily define the Mock rules. Meanwhile, the generated Mock content can be ensured to have good readability, cooperation and communication among team members can be facilitated, and the efficiency of the whole software development process can be improved.

The interface definition language of the application programming interface may be efficiently fused into the interface development process. In addition to the interface structure information defined by API IDL, there is generally a field relationship constraint described in a natural language. The existing technical solutions are difficult to effectively combine these natural language constraints and API IDL information, resulting in the inability to comprehensively consider these constraint conditions when the Mock interface is generated, thereby affecting the accuracy and integrity of the Mock interface. Different from the existing technical solutions, the proposed technical solution may implement natural language constraint and application interface definition. According to the disclosure, the constraint condition described by the natural language can be efficiently fused with the API IDL, so that they are complementary to each other, providing a solid foundation for generating the Mock interface having high quality and conforming to various requirements. In this way, it can be ensured that the Mock interface accurately simulates behaviors of the real interface under various complex service scenarios.

With some implementations of the disclosure, the automation degree of the interface Mock can be greatly improved by means of the powerful capability of the model, and manual intervention can be reduced. Specifically, by analyzing the API IDL and natural language constraint, a high-quality, and directly usable, Mock interface code may be generated automatically. In this way, not only can the development efficiency be improved, but also the error rate caused by human factors can be reduced. Further, a more intelligent and convenient solution can be provided for interface testing and development work in the software development process, and the iteration of the whole software project can be accelerated.

With some implementations of the disclosure, the simulation code may be generated automatically based on the description data of the application programming interface and the constraint conditions represented in the natural language. In this way, manual workload in the application development and testing process can be reduced, and development and testing efficiency can be improved.

### Detailed Procedure for Interface Management

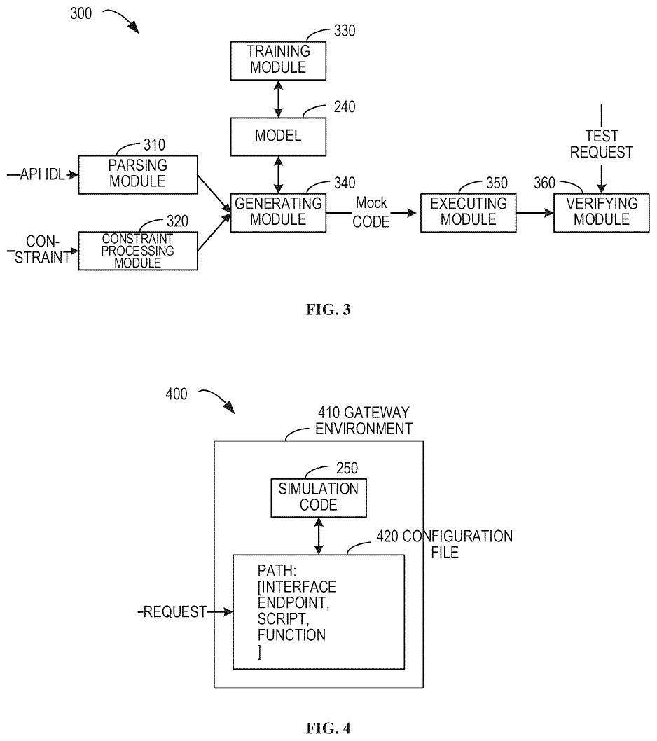

Having described a summary according to some implementations of the disclosure, more details regarding a method for managing an application programming interface will be described below. FIG. 3 shows a block diagram 300 of an architecture of a module for managing an application programming interface according to some implementations of the disclosure. According to some implementations of the disclosure, a plurality of modules may be utilized to manage the application programming interface. Specifically, the plurality of modules may include: a parsing module 310, a constraint processing module 320, a training module 330, a generating module 340, an executing module 350, and a verifying module 360.

As shown in FIG. 3, the parsing module 310 may receive an API IDL and parse the description data related to the multi-aspect information of the interface definition. The constraint processing module 320 may receive a constraint represented in a natural language and determine constraint data for various fields defined in the application programming interface. The description data and the constraint data may be input to the generating module 340, and the generating module 340 may invoke the model 240 to generate the Mock code. Here, the model 240 may be a machine learning model that is sufficiently trained with the training module 330. The executing module 350 may invoke the Mock code to provide a Mock interface. Further, the verifying module 360 may receive the test request and verify whether a function of the Mock interface is correct.

More details of various modules are respectively described below. According to some implementations of the disclosure, the description data of the application programming interface of the application may be obtained by the parsing module 310. Here, the description data may be represented by using IDL. The IDL is a standardized language for defining a software component interface, and is widely applied to fields of distributed systems, cross-language service development, and the like. It allows developers to define interfaces, data types, and methods in a language-independent manner, thereby implementing cross-platform and cross-language communications. The IDL may support cross-language service definitions, may define service interfaces and data structures, and may support implementation of multiple programming languages. For example, a dedicated tool may be used to generate code of different languages from an IDL file.

According to some implementations of the disclosure, the parsing module may parse the information from the API IDL. The module may support multiple IDL formats, and parse multiple common API IDL formats, for example, including but not limited to Protobuf, Thrift, OpenAPISpec, and the like. Different IDL formats may be provided with dedicated syntax and structure for accurately defining API interface information. In this disclosure, a generic flow may be provided to parse different IDL formats.

For example, for the Protobuf format, the content of the IDL file may be read by using a plurality of code libraries such as Python, so as to parse structural information such as an interface endpoint, a request message, and a response message, and key elements such as a type and an identifier of each field. In a simple example, the IDL may specify the Mock interface to be named as “Register,” and includes two fields of “username” and “password”, etc. It should be understood that the content of the IDL is merely illustrative and that the content of the IDL may vary with the function of the API. For example, for an API that performs an item query function, fields of “category” and “number”, and the like may be included.

For the Thrift format, a corresponding Thrift library (different libraries adapted in different programming languages) may be utilized. The IDL file is read first and information such as a service, a method, a parameter type, a structure and the like defined therein is parsed. The Thrift format defines a data type through a form of a similar structure, the parsing process may identify these structures and field information included therein, and extract important content such as a method name, a parameter list, and a return value type corresponding to the service interface. For OpenAPI Spec, the IDL is generally represented in JSON or YAML format. The file content may be read by using an associated code library, and detailed information such as an endpoint path, a request method, a request parameter, a response status code and a data structure of the API may be parsed. After the parsing is completed, the obtained interface information may be transmitted to the subsequent module in the form of an original data structure.

According to some implementations of the disclosure, constraint data may be obtained by using a constraint processing model. The constraint data represents a constraint for a field specified by the description data, and the constraint data is represented in a natural language. The constraint processing module may process a constraint condition represented in a natural language, and the module may receive a constraint condition of a relationship between fields of the natural language description input by the developer, for example, “a username in a registration request should have a length between 6 and 20 bits, and cannot include special characters”, “a password should have a string type with a length of at least 8 bits”, etc. For an API that performs an item query function, the constraint may be represented as: “a category in the request parameter should have a string type with a number greater than 0 and less than 10000”, etc. With some implementations of the disclosure, the constraint processing module may directly transmit the constraint conditions in the natural language form to the subsequent module without additional processing of the constraint condition at this module.

According to some implementations of the disclosure, the Mock code may be generated by using the machine learning model. Here, the machine learning model may be determined by the following steps: obtaining reference log data associated with a reference application programming interface, the reference log data including reference description data of the reference application programming interface and reference constraint data for a reference field specified in the reference description data; and updating the machine learning model by using the reference log data and reference code of the reference application programming interface. With some implementations of the disclosure, the machine learning model may be trained adequately by using historical knowledge in the log data, and the machine learning model may accurately generate the Mock code.

Specifically, the machine learning model may be trained by using the training module 330. The training module 330 may pre-train the machine learning model by using an API gateway log. For example, a training sample may include log data collected by an API gateway of a related application. The log data may include a invoking status of an API in a real environment, for example, information such as an endpoint, a parameter, a timestamp, and the like of the request. It should be understood that pre-processing may be performed on the log data, such as clearing invalid records, clearing data that may involve data security risks, unifying data formats, extracting critical information (such as requested interface names, parameter values, and their corresponding response status codes, etc.), making it suitable as a structured format for pre-training data. The training module may update the machine learning model by using the pre-processed training sample. By enabling the model to learn a data pattern of real API invoking, it may better understand information such as actual use situations, parameter distributions, and common response results of different interfaces.

It should be understood that the machine learning model herein may be a machine learning model for performing specialized tasks. Alternatively and/or additionally, the machine learning model may be a language model for performing generic tasks. Different prompts (e.g., prompt words) may be input to the language model, so that the language model executes a corresponding task.

According to some implementations of the disclosure, in the process of determining the simulation code for simulating the function of the application programming interface by using the machine learning model, the prompt may be generated by using the description data and the constraint data, and the prompt may instruct the machine learning model to generate the simulation code. A response to the prompt from the machine learning model may be received as the simulation code. Specifically, the generating module 340 may invoke the machine learning model to determine the simulation code for simulating the function of the application programming interface based on the description data and the constraint data. In this way, the Mock code may be automatically generated by using the powerful processing capability of the machine learning model.

According to some implementations of the disclosure, the generating module may interact with the machine learning model and generate code that may be compiled and executed correctly. Specifically, the generating module may combine original interface information received from the parsing module and a natural language constraint condition received from the constraint processing module, and may convert the combined comprehensive data structure (for example, including API IDL information and a natural language constraint) into a text format suitable for model input. For example, the prompt is shown in Table 1.

TABLE 1
Prompt Example

```
For User Management related API:
- User Registration Interface:
    - The request parameter includes a username that has a string type, information such as a
  related format is defined in the API IDL (specific content may be supplemented according to
  actual parsing conditions), and according to the natural language constraint, the username
  should have a length between 6 and 20 bits and cannot contain special characters.
    - A password should have a string type and have a length at least 8 bits (which may have
  other constraints or be defined according to the API IDL).
    - The response data includes a user ID (user_id) having an integer type, and a message
    has a string type.
...
```

Further, the generating module may interact with the model and send a generation request to the model. The generation request may specify interface Mock code under a specific programming framework (such as Flask, Spring Boot, etc.) generated in a specific programming language (such as Python, Java, etc.), and the prompt as described above is input to the model. The model may generate corresponding code according to the generation request and the corresponding prompt, and at the same time, consider the API IDL information and the natural language constraint condition. Since the model has been sufficiently trained, the model may refer to the experience of the real API invoking when the Mock code is generated, so that the generated code is closer to the interface behavior in the real environment in logic and results. Specifically, the generated Mock code may be invoked under the specified programming language environment and programming framework, thereby greatly reducing the huge workload of artificially generating the Mock code.

According to some implementations of the disclosure, the prompt may further specify a programming language of the simulation code, and the simulation code is represented in a programming language. Although not shown in Table 1 above, the prompt may further specify that the Mock code is generated by using a programming language such as Python or Java. Alternatively and/or additionally, the prompt may further specify a programming framework in which the simulation code needs to follow. For example, the prompt may further specify to generate Mock code that follows a programming framework such as Flask or Spring Boot. With some implementations of the disclosure, it may be supported that the Mock code is generated in a personalized manner to support the development and testing under different programming languages and programming frameworks.

According to some implementations of the disclosure, the simulation code may be checked in accordance with a syntax rule of the programming language. Specifically, the generating module 340 may also perform preliminary format check and integrity verification on the generated Mock code, and ensure that a basic structure of the Mock code is complete and has no obvious syntactic error. For example, parenthesis matching in the Mock code, whether a keyword is correctly used, whether respective functions are correctly used, and whether routing definition is accurate, etc. may be checked.

According to some implementations of the disclosure, for the prompt shown in Table 1 above, schematic code shown in Table 2 below may be generated. It should be understood that Table 2 shows core information that needs to be included in the Mock code in a pseudo code manner, and in different programming language environments, the Mock code may have different statement formats.

TABLE 2
Schematic Code

| Code Segment | Code |
|---|---|
| . . . | ... |
| 1 | # Process Request Data Verification and Response Generation of User |
| | Registration Interface |
| | Mock_register( ): |
| 2 | # Obtain Username and Password |
| | username = get(‘username’) |
| | password = get(‘password’) |
| 3 | # Verify Constraint of Username |
| | if not (6<=len(username) <=20 and match (‘\hat{ }[a-zA-Z0-9]+$’, username)): |
| | return (“message”: “a length or format of a username does not conform to the |
| | requirement”) |
| 4 | # Verify Password Constraint |
| | if len (password) < 8: |
| | return (“message”: “a length of a password does not conform to the |
| | requirement”) |
| 5 | # Simulating Generation of Response Data Such As Username |
| | user_id =123 |
| | message = “registration successful” |
| | return (“user_id”: user_id, “message”: message) |
| | ... |

In Table 2, the code segment 1 represents that a function of user registration is “Mock_register ( )”, the code segment 2 represents a process of obtaining a username and a password, the code segment 3 represents a process of verifying a username, the code segment 4 represents a process of verifying a password, and the code segment 5 represents a process of simulating generation of a response data such as a username. According to some implementations of the disclosure, the generated Mock code may be edited and/or adjusted so that the code function is more consistent with the intended target.

According to some implementations of the disclosure, the simulation code may be deployed in an execution environment of the application to generate a simulation interface for simulating the function of the application programming interface of the application. Specifically, the executing module may invoke the Mock code and may run in a variety of environments.

According to some implementations of the disclosure, the execution environment may be a gateway environment. In a process of generating a simulation interface for simulating a function of an application programming interface of an application, the simulation code may be deployed at a location specified by the gateway of the application programming interface. A path for accessing the deployed simulation code may be set to generate a simulation interface for simulating the function of the application programming interface of the application. In this way, the Mock code may be supported in the gateway environment.

Further details are described with reference to FIG. 4, FIG. 4 shows a block diagram 400 of deploying the simulation code in the gateway environment according to some implementations of the disclosure. As shown in FIG. 4, the simulation code 250 may be deployed in the gateway environment 410. For example, a code script (e.g., Python) may be hosted at the API gateway. Assuming that the API gateway supports a Python plug-in, the interface Mock code generated by the model may run in an API gateway environment. The API gateway may be responsible for receiving the request and providing a response to the request, e.g., a Python plug-in may be invoked to generate the response content and return.

A routing rule may be configured in the API gateway by using a configuration file 420 (e.g., represented in a JSON or YAML format), and an interface endpoint (e.g.,/register) extracted from API IDL may be associated with a corresponding Python script function. For example, an association relationship may be set in the configuration file of the API gateway. For the schematic code shown in Table 2 above, the association may be performed in a manner as shown in Table 3 below. It should be understood that Table 3 shows core information for performing the association operation in a pseudo code manner, and in different programming language environments, there may be association codes in different formats. As shown in Table 3, a keyword “routes” may represent a path, a keyword “uri” may represent that the interface endpoint is “/register”, a keyword “python_script” may represent that a file of the corresponding storage code script is Mock_register.py, and a keyword “function_name” may represent that a name of the function is Mock_register, etc.

TABLE 3
Association Code

```
...
“routes”: [
  {“uri”: “/register”,
  “python_script”: “Mock_register.py”,
  “function_name”: “Mock_register”},
...
]
...
```

With respect to deployment and execution, the code script may be deployed to a script storage location specified by the API gateway. When a request arrives at a respective endpoint of the API gateway, the API gateway may load a corresponding code script, invoke a configured function, and transmit the request data to the function for processing. Inside the function, whether the request meets a natural language constraint condition (such as a length of a username, a format of a password, etc.) may be verified according to logic previously defined, and then corresponding response data may be generated and returned to the API gateway. The API gateway may return the response data to a client.

According to some implementations of the disclosure, the execution environment may be a webpage integration environment. In a process of generating a simulation interface for simulating a function of an application programming interface of an application, the simulation code may be compiled into a webpage integration module; and the webpage integration module is deployed in the webpage integration environment to generate the simulation interface for simulating the function of the application programming interface of the application. In this way, it may be supported that the Mock code may be invoked in the webpage integration environment

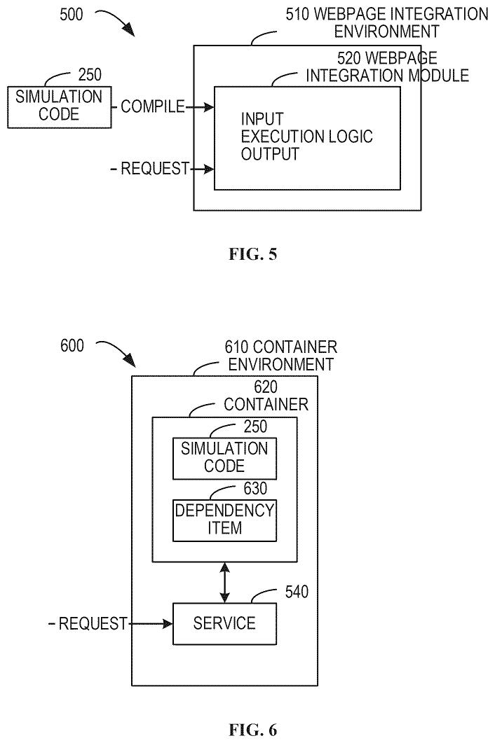

Further details are described with reference to FIG. 5, FIG. 5 shows a block diagram 500 of deploying simulation code in a web page integration environment according to some implementations of the disclosure. As shown in FIG. 5, the simulation code 250 may be compiled into a format of a webpage integration module 520, and a webpage integration module may be deployed in a webpage integration environment 510.

At this time, an executing module 350 may support web page integration (WASM) logic. WASM is a binary instruction format that runs in a browser and other environments. For the generated interface Mock code, the Mock code may be compiled into a WASM module. For example, a variety of tools may be used to compile Python-Flash code (assuming that it is compiled through appropriately modification) into a WASM format. During the compilation process, an input/output interface and an internal execution logic of the WASM module may be configured according to the interface information and the natural language constraint condition parsed by the API IDL. For example, for the/register interface, the WASM module may be configured to receive the username and password, verify whether the username and password meet the constraint, and then generate the corresponding username and message as output.

The compiled WASM module may be deployed into an environment supporting the execution of the WASM, such as some special edge computing devices, Web servers, and the like. When the request arrives at the corresponding interface endpoint, the WASM module may be loaded and executed in the execution environment, and whether the request is processed according to the natural language constraint condition (such as a length of a username and a format of a password) is verified according to the internal logic processing request, and corresponding response data is returned.

According to some implementations of the disclosure, the execution environment may be a container environment. In a process of generating an simulation interface for simulating a function of an application programming interface of an application, a dependency item of the simulation code may be loaded in a container in the container environment; the simulation code may be deployed to the container; and a service for invoking the simulation code in the container may be created to generate the simulation interface for simulating the function of the application programming interface of the application. In this way, it may be supported that the Mock code may be invoked in the container environment.

Further details are described with reference to FIG. 6, FIG. 6 shows a block diagram 600 of deploying simulation code in a container environment according to some implementations of the disclosure. As shown in FIG. 6, the executing module 350 may be implemented in a container environment 610. Specifically, the Mock code may be automatically deployed into the container (e.g., a container 620) of a function as a service (FaaS). The model generated interface Mock code may be executed in the container environment 610.

According to some implementations of the disclosure, a container image may be created, and a dependency item 630 required to run the Mock code may be included in the image, for example, a programming language runtime environment (such as a Python interpreter), a related library, or the like. For the above example, the base image may be specified in the configuration file of the container, necessary libraries are installed (e.g., according to actual IDL parsing and code requirements), and the Mock code is copied into the container. The container image may be deployed into a cluster to provide a FaaS service (e.g., a service 540). A resource may be created to manage a copy of the container, and the Mock service may be supported to be accessible within the cluster. A type of service may be modified to expose the service to the outside of the cluster. When a request arrives at a corresponding API endpoint (such as/register), the cluster may route the request to a running container instance, the container instance executes the Mock code, verifies whether the request conforms to a natural language constraint condition (such as a length of a username, a format of a password, etc.), and returns corresponding response data.

According to some implementations of the disclosure, a test sample for testing the simulation code may be generated by using the machine learning model. The test sample may be provided to the simulation interface in order to test the simulation code. With some implementations of the disclosure, it may be further verified whether the generated simulation code is correct, and potential errors present in the simulation code may be adjusted. The process described above may be performed by using the verifying module 360.

According to some implementations of the disclosure, the verifying module 360 may test sending of the request. Specifically, various test requests may be sent to the Mock interface by using an automated test tool, these test requests may include a normal request that conforms to an interface definition and a constraint condition, and an abnormal request that goes against the constraint condition. For example, for a user registration interface, a normal request including a valid username and password, and an abnormal request in which a username has an insufficient length or it includes special characters, etc. may be sent.

Further, the verifying module 360 may verify the response. Specifically, the verifying module 360 may verify whether the response of the Mock interface conforms to an expectation. In other words, the verifying module may check whether a state code of the response is correct, whether a response data structure is consistent with an API IDL definition, and whether the natural language constraint condition is satisfied. For example, if the registration interface does not meet the requirement on the username, an error status code and a corresponding error information about “a username having a length or a format that does not conform to the requirement” may be returned, the verifying module may check whether the actual response conforms to this requirement, etc.

According to some implementations of the disclosure, in the process of testing the simulation code, the test sample may be processed by using the simulation interface to generate a test result. In response to determining that the test result is consistent with a predicted test result corresponding to the test sample, prompt information indicating that the test is successful may be provided. With some implementations of the disclosure, a running result of the simulation code may be presented in a visualization manner, thereby verifying whether the simulation code is accurate and may be correctly compiled and executed.

Specifically, the verifying module 360 may generate feedback information according to a verification result. If the Mock interface response is correct, the successful test case and related information are recorded; if the response is incorrect, a detailed error type, an error location (such as the number of lines of code), and a difference between the predicted result and an actual result are recorded. These feedback information will be used for subsequent optimization and debugging operations, thereby continually improving the quality and accuracy of the Mock interface. Test reports may be generated, for example, to display the test result in a tabular form, for example as shown in Table 4 below.

TABLE 4
Test Result

| | | | Actual | | | |
|---|---|---|---|---|---|---|
| | | Predicted | Response | | | |
| | | Response | Status | Predicted | Actual | Test |
| ID | Test Request | Status | Code | Response Data | Response Data | Result |
| 1 | Valid Registration | Correct | Correct | “user_id”: 123, | “user_id”: 123, | Success |
| | Request | | | “message”: | “message”: | |
| | (Username: | | | Registration | Registration | |
| | test_user, | | | Successful | Successful | |
| | Password: | | | | | |
| | test_password) | | | | | |
| 2 | Invalid | Error | Error | “message”: | “message”: | Success |
| | Registration | | | Length or Format | Length or | |
| | Request | | | of Username | Format of | |
| | (Username: abc, | | | Does Not | Username Does | |
| | Password: | | | Conform To | Not Conform To | |
| | test_password) | | | Requirement | Requirement | |
| 3 | Invalid | Error | Error | “message”: | “message”: | Success |
| | Registration | | | Length or Format | Length or | |
| | Request | | | of Username | Format of | |
| | (Username: | | | Does Not | Username Does | |
| | test_user@, | | | Conform To | Not Conform To | |
| | Password: | | | Requirement | Requirement | |
| | test_password) | | | | | |
| . . . | . . . | . . . | . . . | . . . | . . . | . . . |

In the context of the disclosure, the overall flow for managing the application programming interface is provided. The flow includes: API IDL parsing, natural language constraint processing, model interaction and code generation, automatic execution of hosted code, and verification and feedback. The above flow may be performed by multiple modules, and the modules may run in a coordinated manner. A method for pre-training the model using an existing API gateway log of a developer's related application is provided, including steps of data collection, preprocessing, and setting appropriate parameters in a pre-training process. Through this pre-training manner, the model generation capability may be improved, and the Mock code approximating the real value may be generated. Further, an interaction processing mechanism with different IDL formats and execution environments is provided: a specific mechanism and a configuration method for automatically executing the Mock code may be implemented for parsing and processing manners of various API IDL formats, and interacting with different execution environments (such as an API gateway, a WASM environment, a container environment, etc.).

In the context of the disclosure, a code generation logic based on the natural language constraint is provided: in the process of fusing the natural language constraint into a model generation interface Mock code, it is ensured that the generated code may accurately follow specific logic and implementations of these constraint conditions, including understanding and conversion for the natural language constraint of the model, and the application in the code generation. The test request may be sent, the response may be verified, and the feedback information may be generated, thereby ensuring the quality and accuracy of the Mock interface. Further, the feedback information may be used for a mechanism of subsequent optimization and debugging.

According to some implementations of the disclosure, using the cooperation of various modules described above, an interface based on multiple forms of API IDL may be implemented to automatically generate the Mock code. In this way, the efficiency, accuracy and intelligence level of the interface Mock can be improved, and powerful support is provided for interface testing and development work in the software development process.

According to some implementations of the disclosure, multi-format API IDL parsing and processing may be supported. Specifically, the technical solution of the disclosure may parse a plurality of common API IDL formats, extract key information such as an interface endpoint, a request message, and a response message, and organize them into a unified structured data model for subsequent module usage. In this way, compatibility processing on different IDL formats may be implemented, and basic data support is provided for the interface automatic Mock.

According to some implementations of the disclosure, the natural language constraint processing may be supported. A field constraint condition of the natural language description input by the developer is received and transferred directly to a model. The model trained by a large number of samples (including pre-training by using an internal API gateway log) may integrate these constraint conditions with the parsed API IDL information, convert the natural language constraint into a prompt that may be used to generate a code, and enable the generated Mock code to meet a specific service logic requirement.

According to some implementations of the disclosure, generation of model driven code may be supported. The interface Mock code under the specific programming language and framework is generated based on the integrated API IDL information and natural language constraint condition by utilizing the powerful natural language processing and code generation capability of the model. In addition, the generated result is closer to the real value by the pre-training, and the efficiency and accuracy of the Mock code generation can be improved.

According to some implementations of the disclosure, it may support automatic execution in a hosted runtime. Specifically, multiple execution manners may be provided, including: hosting Python script execution (adapting an API gateway environment and configuring a routing rule) through an API gateway, WASM execution logic (compiling and configuring the WASM module), and automatically deployed FaaS service mode. In this way, the generated Mock code may be executed in different runtime environments without complex integration operation.

According to some implementations of the disclosure, a verification and feedback mechanism may be supported. Various test requests (including a normal request and an abnormal request) is sent to the automatically executed Mock interface, whether the response conforms to predictions (including aspects such as a state code, a data structure, a natural language constraint, and the like) is verified, and feedback information is generated according to the verification result for subsequent optimization and debugging, so that the quality and accuracy of the Mock interface are ensured.

With some implementations of the disclosure, technical effects that are superior to existing technical solutions may be achieved. The proposed technical solution can improve the efficiency of generating the Mock code. Specifically, the interface definition information may be obtained quickly by parsing and uniformly processing a plurality of common API IDL formats. An accurate basis is provided for subsequent Mock code generation, the tedious process of manually processing different formats is reduced, and the overall flow of the interface Mock is accelerated. With the powerful natural language processing and code generation capability of the model, the Mock code under the expected programming language and framework may be directly generated based on the integrated API IDL information and the natural language constraint condition, without manually writing a large amount of code by the developer, greatly improving the code generation speed, and improving the interface Mock efficiency.

According to some implementations of the disclosure, the Mock code accuracy may be improved. By means of a model trained by a large number of samples (including log pre-training by using the internal API gateway) to have a deeper understanding of the actual use situation, parameter distribution and the like of the API, and the generated Mock code is closer to the interface behavior in the real environment in logic and results. Thus, a matching degree between the Mock code and the real interface may be improved, and the accuracy is enhanced. In the process of generating the Mock code, the field constraint condition described in the natural language are effectively fused into the Mock code, ensuring that the generated code can strictly follow the constraint conditions for request verification and response generation, and further ensuring the accuracy of the Mock code at the service logic level.

With some implementations of the disclosure, the intelligence level of the model may be improved. For example, semantic extraction and data structure organization may be automatically performed on the parsed API IDL information, and the natural language constraint condition may be converted into a format applicable to code generation, so that manual intervention is reduced, and high intelligence degree is exhibited. By automatically adapting and deploying according to different hosted runtime environments, automatic execution of the Mock code is realized without performing complex integrated operation by the developer, which reflects the intelligence of the whole system in the runtime processing.

With some implementations of the disclosure, diversified execution environments may be provided, including various ways such as API gateway hosted Python script execution, WASM execution logic, and automatic deployment to a FaaS service. This enables the disclosure to adapt to different application scenarios and technical architectures, providing more flexibility for developers to select an execution environment.

With some implementations of the disclosure, the Mock interface quality can be effectively ensured. Specifically, the automatically executed Mock interface is comprehensively verified by sending various types of test requests (including a normal request and an abnormal request). Aspects of the response's status code, data structure, and whether the natural language constraint condition is satisfied may be checked, and problems that the Mock interface may exist may be found and recorded in time. Then, the feedback information generated according to the verification result may be used for subsequent optimization and debugging work, and through continuous adjustment and improvement, the quality of the Mock interface is continuously improved, the behavior of the real interface can be accurately simulated, and the interface test and development requirement in the software development process are satisfied.

### Example Process

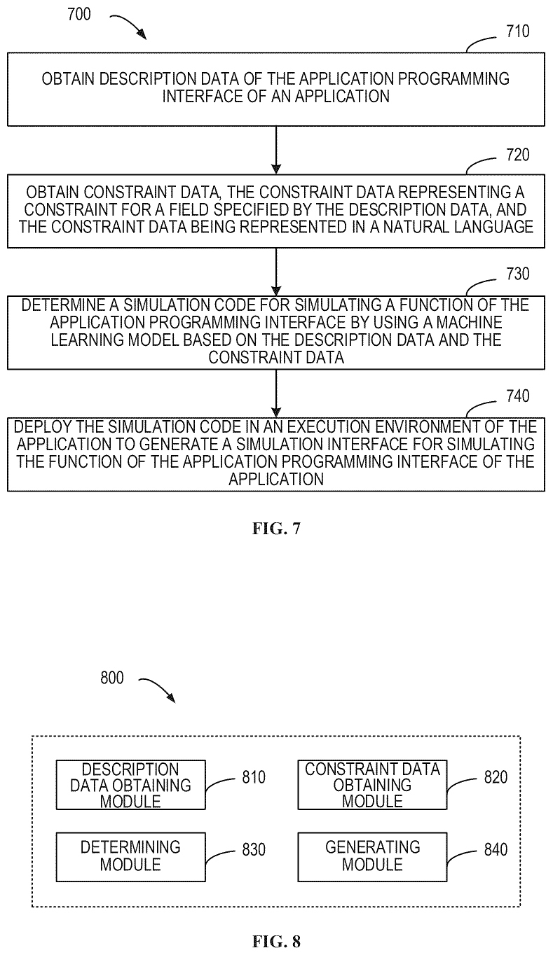

FIG. 7 shows a flowchart of a method 700 for managing an application programming interface according to some implementations of the disclosure. At block 710, description data of the application programming interface of an application is obtained. At block 720, constraint data is obtained, the constraint data represents a constraint for a field specified by the description data, and the constraint data is represented in a natural language. At block 730, based on the description data and the constraint data, simulation code for simulating a function of the application programming interface is determined by using a machine learning model. At block 740, the simulation code is deployed in an execution environment of the application to generate a simulation interface for simulating the function of the application programming interface of the application.

According to some implementations of the disclosure, determining the simulation code for simulating the function of the application programming interface by using the machine learning model includes: generating a prompt by using the description data and the constraint data, the prompt instructing the machine learning model to generate the simulation code; and receiving a response to the prompt from the machine learning model as the simulation code.

According to some implementations of the disclosure, the prompt further specifies a programming language of the simulation code, and the simulation code is represented in the programming language.

According to some implementations of the disclosure, the method 700 further includes: checking the simulation code in accordance with a syntax rule of the programming language.

According to some implementations of the disclosure, the machine learning model is determined by: obtaining reference log data associated with a reference application programming interface, the reference log data including reference description data of the reference application programming interface and reference constraint data for a reference field specified in the reference description data; and updating the machine learning model by using the reference log data and reference code of the reference application programming interface.

According to some implementations of the disclosure, the execution environment is a gateway environment, and generating the simulation interface for simulating the function of the application programming interface of the application includes: deploying the simulation code at a location specified by a gateway of the application programming interface; and setting a path for accessing the deployed simulation code to generate the simulation interface for simulating the function of the application programming interface of the application.

According to some implementations of the disclosure, the execution environment is a webpage integration environment, and generating the simulation interface for simulating the function of the application programming interface of the application includes: compiling the simulation code into a webpage integration module; and deploying the webpage integration module in the webpage integration environment to generate the simulation interface for simulating the function of the application programming interface of the application.

According to some implementations of the disclosure, the execution environment is a container environment, and generating the simulation interface for simulating the function of the application programming interface of the application includes: loading a dependency item of the simulation code in a container in the container environment; deploying the simulation code to the container; and creating a service for invoking the simulation code in the container to generate the simulation interface for simulating the function of the application programming interface of the application.

According to some implementations of the disclosure, the method 700 further includes: generating a test sample for testing the simulation code by using the machine learning model; and providing the test sample to the simulation interface in order to test the simulation code.

According to some implementations of the disclosure, testing the simulation code includes: processing the test sample by using the simulation interface to generate a test result; and in response to determining that the test result is consistent with a prediction test result corresponding to the test sample, providing prompt information indicating that the test is successful.

### Example Apparatus and Device

FIG. 8 shows a block diagram of an apparatus 800 for managing an application programming interface according to some implementations of the disclosure. The apparatus includes: a description data obtaining module 810 configured to obtain description data of the application programming interface of an application; a constraint data obtaining module 820 configured to obtain constraint data, the constraint data representing a constraint for a field specified by the description data, and the constraint data being represented in a natural language; a determining module 830 configured to determine a simulation code for simulating a function of the application programming interface by using a machine learning model based on the description data and the constraint data; and a generating module 840 configured to deploy the simulation code in an execution environment of the application to generate a simulation interface for simulating the function of the application programming interface of the application.

According to some implementations of the disclosure, the determining module 830 is further configured to: generate a prompt by using the description data and the constraint data, the prompt instructing the machine learning model to generate the simulation code; and receive a response to the prompt from the machine learning model as the simulation code.

According to some implementations of the disclosure, the prompt further specifies a programming language of the simulation code, and the simulation code is represented in the programming language.

According to some implementations of the disclosure, the apparatus 800 further includes a processing module configured to check the simulation code in accordance with a syntax rule of the programming language.

According to some implementations of the disclosure, the machine learning model is determined by: obtaining reference log data associated with a reference application programming interface, the reference log data including reference description data of the reference application programming interface and reference constraint data for a reference field specified in the reference description data; and updating the machine learning model by using the reference log data and reference code of the reference application programming interface.

According to some implementations of the disclosure, the execution environment is a gateway environment, and the generating module 840 is further configured to: deploy the simulation code at a location specified by a gateway of the application programming interface; and set a path for accessing the deployed simulation code to generate the simulation interface for simulating the function of the application programming interface of the application.

According to some implementations of the disclosure, the execution environment is a webpage integration environment, and the generating module 840 is further configured to: compile the simulation code into a webpage integration module; and deploy the webpage integration module in the webpage integration environment to generate the simulation interface for simulating the function of the application programming interface of the application.

According to some implementations of the disclosure, the execution environment is a container environment, and the generating module 840 is further configured to: load a dependency item of the simulation code in a container in the container environment; deploy the simulation code to the container; and create a service for invoking the simulation code in the container to generate the simulation interface for simulating the function of the application programming interface of the application.

According to some implementations of the disclosure, the processing module is further configured to: generate a test sample for testing the simulation code by using the machine learning model; and provide the test sample to the simulation interface in order to test the simulation code.

According to some implementations of the disclosure, the processing module is further configured to: process the test sample by using the simulation interface to generate a test result; and provide prompt information indicating that the test is successful in response to determining that the test result is consistent with a predicted test result corresponding to the test sample.

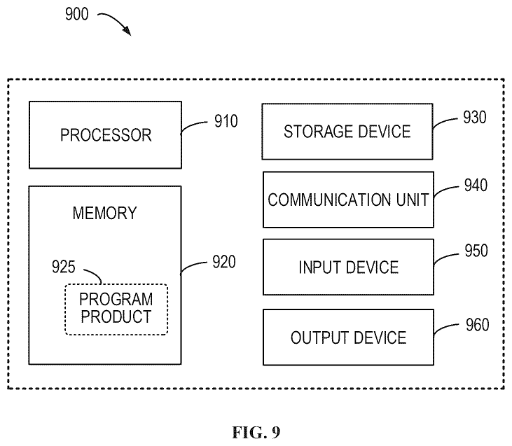

FIG. 9 shows a block diagram of a device 900 in which various implementations of the disclosure may be implemented. It should be understood that a computing device 900 shown in FIG. 9 is merely illustrative and should not constitute any limitation on the functionality and scope of the implementations described herein. The computing device 900 shown in FIG. 9 may be configured to implement the method described above.

As shown in FIG. 9, the computing device 900 is in a form of a general-purpose computing device. Components of the computing device 900 may include, but are not limited to, one or more processors 910, a memory 920, a storage device 930, one or more communication units 940, one or more input devices 950, and one or more output devices 960. The processor 910 may be an actual or virtual processor and may perform various processes according to programs stored in the memory 920. In a multiprocessor system, multiple processors execute computer-executable instructions in parallel to improve the parallel processing capability of the computing device 900.

The computing device 900 generally includes a plurality of computer storage media. Such media may be any available media accessible by the computing device 900, including, but not limited to, volatile and non-volatile media, removable and non-removable media. The memory 920 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 930 may be a removable or non-removable medium and may include a machine-readable medium, such as a flash drive, a magnetic disk, or any other medium, which may be configured to store information and/or data (e.g., training data for training) and may be accessed within the computing device 900.

The computing device 900 may further include additional removable/non-removable, volatile/non-volatile storage media/medium. Although not shown in FIG. 9, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 920 may include a computer program product 925 having one or more program modules configured to perform various methods or actions of various implementations of the disclosure.

The communications unit 940 implements communications with other computing devices through communication medium/media. Additionally, the functionality of components of the computing device 900 may be implemented in a single computing cluster or multiple computing machines, which may communicate through a communication connection. Thus, the computing device 900 may operate in a networked environment using logical connection(s) with one or more other servers, a network personal computer (PC), or another network node.

The input device 950 may be one or more input devices such as a mouse, a keyboard, a trackball, or the like. The output device 960 may be one or more output devices, such as a display, a speaker, a printer, or the like. The computing device 900 may also communicate with one or more external devices (not shown) as needed, the external device such as a storage device, a display device, or the like, communicates with one or more devices that enable a user to interact with the computing device 900, or communicates with any device (e.g., a network card, a modem, etc.) that enables the computing device 900 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, and the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processor of a general purpose computer, special purpose computer, or other programmable data processing apparatus to produce a machine, such that the instructions, when executed by a processor of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing an application programming interface, comprising:
obtaining description data of the application programming interface of an application;
obtaining constraint data, the constraint data representing a constraint for a field specified by the description data, and the constraint data being represented in a natural language;
determining simulation code for simulating a function of the application programming interface by using a machine learning model based on the description data and the constraint data; and
deploying the simulation code in an execution environment of the application to generate a simulation interface for simulating the function of the application programming interface of the application.

2. The method of claim 1, wherein determining the simulation code for simulating the function of the application programming interface by using the machine learning model comprises:
generating a prompt by using the description data and the constraint data, the prompt instructing the machine learning model to generate the simulation code; and
receiving a response to the prompt from the machine learning model as the simulation code.

3. The method of claim 1, wherein the prompt further specifies a programming language of the simulation code, and the simulation code is represented in the programming language.

4. The method of claim 3, further comprising: checking the simulation code in accordance with a syntax rule of the programming language.

5. The method of claim 1, wherein the machine learning model is determined by:
obtaining reference log data associated with a reference application programming interface, the reference log data comprising reference description data of the reference application programming interface and reference constraint data for a reference field specified in the reference description data; and
updating the machine learning model by using the reference log data and reference code of the reference application programming interface.

6. The method of claim 1, wherein the execution environment is a gateway environment, and generating the simulation interface for simulating the function of the application programming interface of the application comprises:
deploying the simulation code at a location specified by a gateway of the application programming interface; and
setting a path for accessing the deployed simulation code to generate the simulation interface for simulating the function of the application programming interface of the application.

7. The method of claim 1, wherein the execution environment is a webpage integration environment, and generating the simulation interface for simulating the function of the application programming interface of the application comprises:
compiling the simulation code into a webpage integration module; and
deploying the webpage integration module in the webpage integration environment to generate the simulation interface for simulating the function of the application programming interface of the application.

8. The method of claim 1, wherein the execution environment is a container environment, and generating the simulation interface for simulating the function of the application programming interface of the application comprises:
loading a dependency item of the simulation code in a container in the container environment;
deploying the simulation code to the container; and
creating a service for invoking the simulation code in the container to generate the simulation interface for simulating the function of the application programming interface of the application.

9. The method of claim 1, further comprising:
generating a test sample for testing the simulation code by using the machine learning model; and
providing the test sample to the simulation interface to test the simulation code.

10. The method of claim 9, wherein testing the simulation code comprises:
processing the test sample by using the simulation interface to generate a test result; and
providing prompt information indicating that the test is successful in response to determining that the test result is consistent with a predicted test result corresponding to the test sample.

11. An electronic device, comprising:
at least one processor; and
at least one memory coupled to the at least one processor and storing instructions for execution by the at least one processor, the instructions, when executed by the at least one processor, causing the electronic device to perform acts comprising:
obtaining description data of the application programming interface of an application;
obtaining constraint data, the constraint data representing a constraint for a field specified by the description data, and the constraint data being represented in a natural language;
determining simulation code for simulating a function of the application programming interface by using a machine learning model based on the description data and the constraint data; and
deploying the simulation code in an execution environment of the application to generate a simulation interface for simulating the function of the application programming interface of the application.

12. The electronic device of claim 11, wherein determining the simulation code for simulating the function of the application programming interface by using the machine learning model comprises:
generating a prompt by using the description data and the constraint data, the prompt instructing the machine learning model to generate the simulation code; and
receiving a response to the prompt from the machine learning model as the simulation code.

13. The electronic device of claim 11, wherein the prompt further specifies a programming language of the simulation code, and the simulation code is represented in the programming language.

14. The electronic device of claim 13, wherein the acts further comprise: checking the simulation code in accordance with a syntax rule of the programming language.

15. The electronic device of claim 11, wherein the machine learning model is determined by:
obtaining reference log data associated with a reference application programming interface, the reference log data comprising reference description data of the reference application programming interface and reference constraint data for a reference field specified in the reference description data; and
updating the machine learning model by using the reference log data and reference code of the reference application programming interface.

16. The electronic device of claim 11, wherein the execution environment is a gateway environment, and generating the simulation interface for simulating the function of the application programming interface of the application comprises:
deploying the simulation code at a location specified by a gateway of the application programming interface; and
setting a path for accessing the deployed simulation code to generate the simulation interface for simulating the function of the application programming interface of the application.

17. The electronic device of claim 11, wherein the execution environment is a webpage integration environment, and generating the simulation interface for simulating the function of the application programming interface of the application comprises:
compiling the simulation code into a webpage integration module; and
deploying the webpage integration module in the webpage integration environment to generate the simulation interface for simulating the function of the application programming interface of the application.

18. The electronic device of claim 11, wherein the execution environment is a container environment, and generating the simulation interface for simulating the function of the application programming interface of the application comprises:
loading a dependency item of the simulation code in a container in the container environment;
deploying the simulation code to the container; and
creating a service for invoking the simulation code in the container to generate the simulation interface for simulating the function of the application programming interface of the application.

19. The electronic device of claim 11, further comprising:
generating a test sample for testing the simulation code by using the machine learning model; and
providing the test sample to the simulation interface to test the simulation code.

20. A non-transitory computer-readable storage medium having stored thereon computer instructions that, when executed by a processor, cause the processor to perform acts comprising:
obtaining description data of the application programming interface of an application;
obtaining constraint data, the constraint data representing a constraint for a field specified by the description data, and the constraint data being represented in a natural language;
determining simulation code for simulating a function of the application programming interface by using a machine learning model based on the description data and the constraint data; and
deploying the simulation code in an execution environment of the application to generate a simulation interface for simulating the function of the application programming interface of the application.
